(19) United States
(12) Patent Application Publication
(10) Pub. No.: US 2005/0167538 A1
(43) Pub. Date: Aug. 4, 2005

(54) Refiner fittings for paper fiber stock

(75) Inventors: Klaus Doelle, Kisslegg (DE); Achim Schroeder, Odenthal (DE); Werner Hoessle, Bergatreute (DE); Norbert Walter, Ravensburg (DE)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenhein (DE)

(21) Appl. No.: 11/046,846

(22) Filed: Feb. 1, 2005

(30) Foreign Application Priority Data
Feb. 4, 2004 (DE) 20 2004 001 620.6

(51) Int. Cl. B02C 7/12

(52) U.S. Cl. 241/298

(57) ABSTRACT

Refiner fitting and process of forming a refiner fitting, which includes a base body, and at least two knife sectors detachably coupled to the base body to form a working side. The knife sectors include grooves and at least three refiner strips, and the knife sectors and refiner strips are structured to form one continuous part. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 20 2004 001 620.6, filed on Feb. 4, 2004, the disclosure of which is expressly incorporated by reference herein in its entirety.

### BACKGROUND OF THE INVENTION

1. Field of the Invention

The present invention relates to a fitting for the mechanical processing, in particular refining, of a paper fiber suspension in a refiner machine. In this manner, the fitting has a working side with an element in the form of grooves and refiner strips for processing the suspended fibrous material and a back with which it can be mounted on the fitting carrier of the refiner machine.

2. Discussion of Background Information

Fittings of this type are used to refine fiber stock suspended in water. They have refiner strips and grooves on the work surfaces located on the front, which is why they are also called “knife fittings.” In refining in refiners, the suspension usually has a solids content of approx. 2-8%. Refiner machines that are provided with fittings of this type have at least one rotor and at least one stator with disk-shaped or cone-shaped surfaces on which the fittings are attached by the back such that they respectively have a relatively large contact surface with the rotor or stator. Thus, a rotor or stator of this type serves as a fitting carrier.

The shape, material and surface of the fittings have an overriding influence on the processing effect. It is therefore understandable that considerable expense is involved in the development and production of fittings that is reflected in the design of their shape and in the selection of the material. The effect in terms of fiber technology and energy is initially of central importance. This has led to a number of fittings which are very suitable from a technical point of view but which have the disadvantage of being relatively expensive.

Fittings are tools that are to be installed in corresponding refiner machines. If, as usual, they are subjected to greater wear, they have to be replaced at certain intervals, which leads to continuous additional costs.

### SUMMARY OF THE INVENTION

The present invention is directed to design fittings of the above-mentioned type in which costs due to wear can be reduced.

According to the invention, the fitting includes a base body on which at least two knife sectors are detachably fastened, and the knife sectors have at least three, and preferably at least ten, refiner strips. Further, the knife sector and the associated refiner strips form one continuous part.

The refiner fitting according to the invention offers the possibility of detaching the wear-susceptible parts from the base plate and replacing them, if necessary. The base plate can, therefore, be used again, which leads to considerable cost savings, since as a rule it is made of a stainless, tough, high quality metal alloy.

Splitting the fitting makes it possible to produce the knife sectors from a different material than the base plate, which, as a rule, is an advantage, since the demands on the refiner strips are very different from those on the base plate.

Smaller machines can be used in the machining of the knife sectors, particularly when inserting grooves, rather than machining the fittings as a whole. The process of grinding or milling grooves that is expensive per se is thus made cheaper so that it is more frequently possible to use the advantages of a fitting thus produced, i.e., narrow grooves/knives are often desirable for reasons of refining technology. Since casting slopes are dispensed with, a greater flow surface in the grooves can be provided for the fibrous stock suspension.

The present invention is directed to a refiner fitting including a base body, and at least two knife sectors detachably coupled to the base body to form a working side. The knife sectors include grooves and at least three refiner strips, and the knife sectors and refiner strips are structured to form one continuous part.

According to a feature of the instant invention, the working side is structured and arranged for processing suspended fibrous material, and the knife sectors may further include a back side to be detachably coupled to said base body.

In accordance with another feature of the invention, the knife sectors can include at least ten refiner strips.

Further, the refiner fitting can be structured and arranged for at least one of mechanical processing and refining a paper fiber suspension in a refiner machine. The refiner fitting may be structured and arranged to be mounted on a fitting carrier of the refiner machine.

According to still another feature of the present invention, the refiner strips may be laterally delimited by profile-ground grooves.

In accordance with still another feature of the invention, the knife sectors can be formed from a flat steel.

In accordance with the invention, the knife sectors can be detachably coupled to the base body by screws.

According to a further feature of the present invention, at least one holding device can be structured and arranged to be screwed onto the base body. The knife sectors may be positively connected to the base body by the at least one holding device. Moreover, the holding device may be a peripherally mounted clamping ring.

In accordance with a still further feature of the instant invention, a centering flange can be included, such that the knife sectors can be adjusted on the base body with the aid of the centering flange.

At least a portion of the refiner strips arranged to contact fiber stock may have a rectangular profile.

Moreover, the refiner fitting can be structured as one of a circular ring or a circular ring segment.

According to another feature of the present invention, the refiner strips of a respective knife sector can be parallel to one another.

In accordance with the invention, the knife sectors can be identical to one another with regard to shape and to angle of the refiner strips. Further, the knife sector shape can be trapezoidal and the refiner strips may be oriented obliquely to a radius of the refiner fitting.

According to the instant invention, a refiner surface of the refiner strips may be level.

According to another feature, the base body may include angular elevations with a minimum height of 2 mm on parts of the working side that are not covered by knife sectors.

The instant invention is directed to a process of forming a refiner fitting having a base body and at least two knife sectors detachably coupled to the base body to form a working side. The process includes cutting knife sectors from flat steel plate, one of milling or profile grinding a surface of the knife sector to make grooves that form refiner strips, and detachably coupling at least two knife sectors to a base body.

In accordance with still yet another feature of the present invention, the refiner fittings can form at least one of a circular ring or a circular ring segment, and the knife sector may be trapezoidal shaped.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a fitting according to the invention in plan view;

FIG. 2 illustrates a variant of the form depicted in FIG. 1;

FIG. 3 illustrates a side sectional view of a fitting according to the invention; and

FIG. 4 diagrammatically illustrates the manufacture of plates for the production of the knife sectors.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

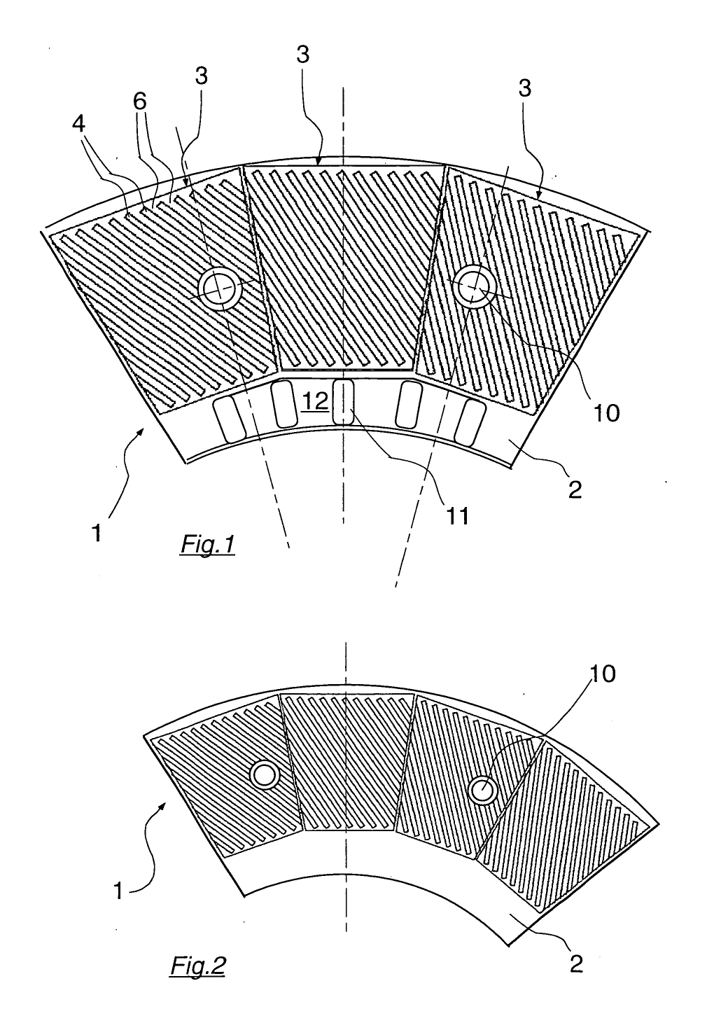

FIG. 1 shows a fitting 1 designed according to the invention in the form of a circular ring segment. By way of example, six of such circular ring segments can be combined to form a complete circular ring, however, any number of such segments can be utilized depending upon their angular extent. The exemplary fitting illustrated includes three knife sectors 3 that are attached to base body 2 and largely cover it in this view. Knife sectors 3 are provided with a larger number of refiner strips 4 between which grooves 6 are located. All knife sectors 3 used in this fitting are designed in the same manner, apart from screw holes 10 for the mounting screws. That is, in particular the angle, knife width, groove width are essentially identical. This reduces the cost of manufacturing the fitting. However, it is also conceivable that fitting patterns are used that deviate from that illustrated in FIG. 1 and/or from each other. The three knife sectors 3 are also identical with regard to knife angle and knife shape. Nevertheless, due to the oblique orientation of refiner strips 4 and grooves 6 with respect to the radius, the knife angles with respect to the radius are smaller than if the entire fitting were provided with parallel strips, which is an advantage that results from splitting a fitting into several knife sectors.

As a rule, a fitting of this type is attached with screws to the rotor or stator of the refiner machine, e.g., via screw holes 10. Expediently, screw holes 10 are arranged to exhibit the same spacings or the same angles on the circumference. In order to avoid this, knife sectors 3 provided with screw holes have to be produced in a non-uniform manner, e.g., as shown in FIG. 1, or a straight-line number of knife sectors per fitting can be provided, as shown in FIG. 2. All the knife sectors with screw holes can then be identical even with a uniform bore pattern of the mounting screws.

It is also discernible in this figure that angular elevations 11 are installed on the base body for pretreating the paper fiber stock before it is refined between refiner strips 4. They can be installed individually on base body 2 or in groups on a carrier element 12. Experience has shown that these elevations are subjected only to very slight wear, so that they can remain during the usual fitting change or at least are not replaced at each fitting change.

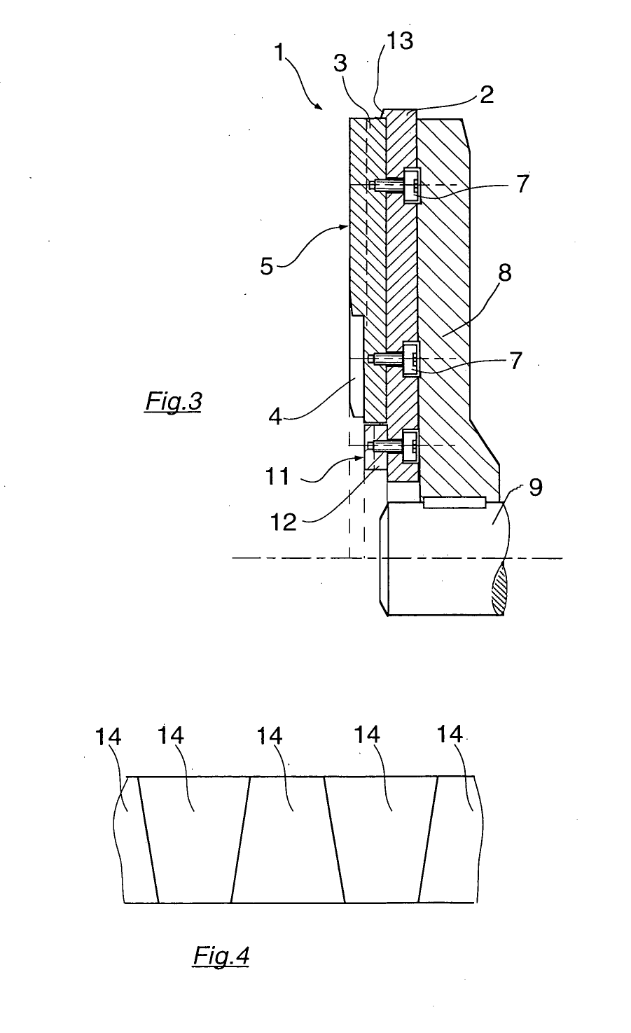

FIG. 3 shows in side view a fitting 1 according to the invention in an installed condition in a refiner machine that is merely indicated. It is attached to rotor 8 of a refiner machine, which is driven by a shaft 9. Fitting 1 has a base body 2 with knife sectors 3 attached thereto. On its working side, knife sector 3 is provided with refiner strips 4 that are used for processing suspended fibrous material and, in this exemplary embodiment, form a level refiner surface 5. Knife sector 3 and refiner strips 4 form one continuous part, and, thus, are made from one piece. Production can be carried out by first making a plate 14 of flat steel and then milling or profile grinding grooves 6 in plate 14. The above-mentioned refiner strips 4 then remain between grooves 6. Because the material used for knife sectors 3 is relatively expensive, trapezoidal plates 14, as shown in the exemplary embodiments of FIGS. 1 and 2, can be cut from flat steel with low material loss (see FIG. 4).

Knife sector 3 is detachably connected to base body 2 by screws 7. This figure does not show the screw connection that is normally used in order to connect the entire fitting to rotor 8. When a worn fitting is replaced, knife sector 3 and base plate 2 can already be installed before the refiner machine is opened, so that the stoppage times that result from the replacement of the fitting itself can be kept short.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A refiner fitting, comprising:
a base body;
at least two knife sectors detachably coupled to said base body to form a working side;
said knife sectors comprising grooves and at least three refiner strips, and said knife sectors and said refiner strips being structured to form one continuous part.

2. The refiner fitting in accordance with claim 1, wherein said working side is structured and arranged for processing suspended fibrous material, and said knife sectors further comprise a back side to be detachably coupled to said base body.

3. The refiner fitting in accordance with claim 1, wherein said knife sectors comprise at least ten refiner strips.

4. The refiner fitting in accordance with claim 1, wherein said refiner fitting is structured and arranged for at least one of mechanical processing and refining a paper fiber suspension in a refiner machine.

5. The refiner fitting in accordance with claim 4, wherein said refiner fitting is structured and arranged to be mounted on a fitting carrier of the refiner machine.

6. The refiner fitting in accordance with claim 1, wherein said refiner strips are laterally delimited by profile-ground grooves.

7. The refiner fitting in accordance with claim 1, wherein said knife sectors are formed from a flat steel.

8. The refiner fitting in accordance with claim 1, wherein said knife sectors are detachably coupled to said base body by screws.

9. The refiner fitting in accordance with claim 1, further comprising at least one holding device structured and arranged to be screwed onto said base body, wherein said knife sectors are positively connected to said base body by said at least one holding device.

10. The refiner fitting in accordance with claim 9, wherein said holding device is a peripherally mounted clamping ring.

11. The refiner fitting in accordance with claim 1, further comprising a centering flange, wherein said knife sectors are adjusted on said base body with the aid of said centering flange.

12. The refiner fitting in accordance with claim 1, wherein at least a portion of said refiner strips arranged to contact fiber stock have a rectangular profile.

13. The refiner fitting in accordance with claim 1, wherein said refiner fitting is structured as one of a circular ring or a circular ring segment.

14. The refiner fitting in accordance with claim 1, wherein said refiner strips of a respective knife sector are parallel to one another.

15. The refiner fitting in accordance with claim 1, wherein said knife sectors are identical to one another with regard to shape and to angle of said refiner strips.

16. The refiner fitting in accordance with claim 15, wherein said knife sector shape is trapezoidal and said refiner strips are oriented obliquely to a radius of said refiner fitting.

17. The refiner fitting in accordance with claim 1, wherein a refiner surface of said refiner strips is level.

18. The refiner fitting in accordance with claim 1, wherein said base body includes angular elevations with a minimum height of 2 mm on parts of said working side that are not covered by knife sectors.

19. A process of forming a refiner fitting having a base body and at least two knife sectors detachably coupled to the base body to form a working side, said process comprising:
cutting knife sectors from flat steel plate;
one of milling or profile grinding a surface of the knife sector to make grooves that form refiner strips; and
detachably coupling at least two knife sectors to a base body.

20. The process in accordance with claim 19, wherein the refiner fittings form at least one of a circular ring or a circular ring segment, and the knife sector is trapezoidal shaped.
